(19) United States
(12) Patent Application Publication
(10) Pub. No.: US 2007/0111662 A1
(43) Pub. Date: May 17, 2007

(54) Method and system for rapidly setting up a communication between a disk drive and a plurality of communicating objects

(75) Inventors: Fabien Beckers, Paris (FR); Edward Colby, Cambridge (GB)

Correspondence Address: FULBRIGHT & JAWORSKI, LLP, 666 FIFTH AVE, NEW YORK, NY, 10103-3198, US

(73) Assignee: KAMELEON, Nanterre (FR)

(21) Appl. No.: 10/564,377

(22) PCT Filed: Jul. 9, 2004
(86) PCT No.: PCT/FR04/50326

§ 371 Date: Dec. 12, 2006

(30) Foreign Application Priority Data
Jul. 11, 2003 (FR) 03 08558

(51) Int. Cl. H04B 7/00

(52) U.S. Cl. 455/41.2; 455/509; 340/10.1; 340/825.71; 455/574

(57) ABSTRACT

The invention concerns a method and a system for rapidly establishing a Bluetooth type communication between a reader and a communicating object. The Bluetooth type communication protocol implements a radio frequency communication process on channels having specific frequencies. The specific frequencies are divided into a first subgroup of frequencies and a second subgroup of frequencies. Each communicating object of alternately and successively selects a frequency from the first subgroup of frequencies followed by a frequency from the second subgroup of frequencies. The reader randomly selects the first subgroup of frequencies or the second subgroup of frequencies, and performs frequency scans of the selected subgroup of frequencies before performing a scan of the other subgroup of frequencies.

### CROSS-REFERENCE TO RELATED APPLICATIONS

This application is a §371 from PCT/FR2004/050326 filed Jul. 9, 2004, which claims priority from FR 03/08558 filed Jul. 11, 2003, each of which is herein incorporated by reference in its entirety.

### FIELD OF THE INVENTION

The present invention concerns a method and a system for rapidly establishing a communication between a reader and a plurality of communicating objects.

The volume of data that users are increasingly trying to obtain, particularly when using communications networks like the Internet, is constantly growing. These data are time-consuming and difficult to obtain when they concern a product or a specific object. The invention seeks to facilitate access to these data.

### THE PRIOR ART

There is a known communication protocol called Bluetooth that makes it possible to place objects located in the same environment in communication via wireless links and to exchange data between the objects.

Bluetooth was designed to guarantee a lack of interference between various products communicating with one another. To accomplish this, the Bluetooth protocol works by dividing the 2.45 GHz frequency band into sub-frequencies.

In order to eliminate any risk of interference during a communication, two elements agree to communicate on one of these frequencies.

The connection principle is as follows. First, there is an “inquiry” process, in order to find the Bluetooth elements present to which a device can connect, and then there is a “page” process, which makes it possible to connect to a specified element using its (unique) Bluetooth address, obtained by means of the inquiry process.

When two Bluetooth objects are located within a radius of approximately 10 meters, they seek each other by hopping from one sub-frequency to another based on an algorithm, until they find each other. At this stage, each object notices that another Bluetooth device is trying to start a communication. They then begin a new random search sequence, and this second time around, they exchange their (unique) Bluetooth address, written by the manufacturer into the processor.

Once each of the elements has exchanged its identification number, one of the Bluetooth devices can decide to establish a connection with another element by naming it with its Bluetooth address. It then initiates a request containing the identifier in question, and the device involved responds by accepting the establishment of the connection. Once the connection is established, the two devices can freely exchange information.

The technological challenge consists of making the Bluetooth protocol work with a communicating object that is not connected to any main power source, such as a rechargeable battery or a direct connection to a mains supply. In fact, as mentioned above, all of the research and development currently involving Bluetooth is focused on devices fed by a main power source, because of the high power consumption of the processor during the sending, receiving and connection phases (Ex: telephone, printer, computers, etc.). Moreover, given the complexity of the protocol, the connection process can take up to 10 s.

Given the power consumed, it is impossible, with such long connection times, to make Bluetooth run on a battery, away from a main power source, for a period of more than one day. One of the objects of the invention is to obtain a service life of at least one year. One of the objects of the invention is to considerably reduce the connection time and thereby extend the service life to one year.

Furthermore, the Bluetooth protocol is inappropriate when the objects to be placed in communication must be of small size.

The solution according to the invention described below applies to a connection between a standard Bluetooth device (the reader) and a specific Bluetooth element (the communicating object, also called the chip).

### OBJECT AND SUMMARY OF THE INVENTION

More specifically, the object of the invention is to make it possible to establish a communication, particularly a Bluetooth type communication, that is considerably faster and less power-hungry than the protocols known to date.

The invention also makes it possible to integrate microprocessors, particularly Bluetooth type microprocessors, into small-size, low-cost chips.

The chips according to the invention also make it possible to exchange information with electronic equipment using standard communication protocols, such as for example the Bluetooth protocol.

The invention concerns a method for rapidly establishing a Bluetooth type communication between at least one reader, particularly a standard reader, and at least one communicating object, particularly in the form of a chip. The communicating object and the reader have a Bluetooth type communication protocol. The communicating object has a communication address. The Bluetooth type communication protocol implements a radio frequency communication process on channels having specific frequencies. The specific frequencies are divided into a first subgroup of frequencies and a second subgroup of frequencies. The method according to the invention comprises the following steps:
the step, for the reader, of sending a Bluetooth request, establishing the communication process in order to determine whether at least one communicating object is present in the environment in which the reader is located,
the step, for the communicating object that receives the request, of revealing its presence via a response signal, then transmitting its communication address to the reader,
the step, for the reader, of selecting, from among the communication addresses of the communicating objects present, that of at least one communicating object with which the reader must exchange information.

The method also comprises, in order to implement the communication process, the following steps:
the step, for each communicating object, of alternately and successively selecting a frequency from the first subgroup of frequencies followed by a frequency from the second subgroup of frequencies,
the step, for the reader, of randomly selecting the first subgroup of frequencies or the second subgroup of frequencies,
the step, for the reader, of performing several frequency scans of the frequencies in the selected subgroup of frequencies before performing a frequency scan of the other subgroup of frequencies.

It is thus possible, thanks to this combination of technical features, to reduce the time required for the reader and the communicating object in question to find the frequency of the channel on which they can exchange information.

The software installed in the reader is designed to allow the execution of the steps described above.

In the case where the reader is a mobile telephone, the software is integrated into it during production or is downloaded into the mobile telephone from a local source (a tag or chip) or from a website.

In a variant of embodiment of the invention, the reader is associated with a mobile telephone unit, particularly a GSM unit. Preferably according to the invention, in this variant of embodiment, the method also comprises the following steps:
the step, for the communicating object, of detecting the GSM signals sent by the mobile telephone unit,
the step, for the communicating object, of activating, based on the GSM signals thus detected, the sending of the response signal to the request.

It is thus possible to reduce the power consumption of the communicating object by activating the sending of the response signal only at the appropriate time.

In another variant of embodiment of the invention, the communication protocol comprises standby phases and active phases. Preferably according to the invention, in this embodiment, the method also comprises the step of adapting the duration of the standby phases to the number of requests sent by the readers.

In another variant of embodiment, the method also comprises the step of establishing a Bluetooth connection between said reader and said communicating object in question, using said frequency of the channel on which they can exchange information.

In the case of this embodiment, the specific information includes a piece of information required by said reader to establish a Bluetooth type connection with the communicating object.

In another variant of embodiment of the invention, the method also comprises the following steps:
the step of giving one of the communicating objects the status of master communicating object relative to the other communicating objects, which have the status of slave communicating objects,
the step, for the master communicating object, of collecting the communication address and/or the specific information from the slave communicating objects,
the step, for the master communicating object, of responding to the requests sent by the reader.

As a result of this combination of technical features, the reader collects all of the information from the communicating objects.

Preferably according to the invention, in this other variant of embodiment, the method also comprises the step, for the master communicating object, of transferring to another communicating object the status of master communicating object.

Preferably according to the invention, in this other variant of embodiment, the method also comprises the following steps:
the step, for the previous master communicating object, of communicating to the new master communicating object the information it has concerning the other communicating objects,
the step, for the new master communicating object, of verifying the information from the previous master communicating object.

In an advantageous variant of embodiment, the method is activated by means of an application, said application allowing the method to be activated by a simple action, particularly a click, from a user of the communicating object.

The presence of a user-friendly application linked to the communicating object and allowing the method according to the invention to be activated makes the method easy to use and to implement.

The invention concerns a system for rapidly establishing a Bluetooth type communication between at least one reader, particularly a standard reader, and at least one communicating object, particularly in the form of a chip. The communicating object and the reader have a Bluetooth type communication protocol. The communicating object has a communication address. The Bluetooth type communication protocol implements a radio frequency communication process on channels having specific frequencies. The specific frequencies are divided into a first subgroup of frequencies and a second subgroup of frequencies. The system according to the invention is such that:
the reader comprises first sending means for sending a Bluetooth request, establishing the communication process in order to determine whether at least one communicating object is present in the environment in which the reader is located,
each communicating object that receives the request comprises second sending means for sending a response signal revealing its presence and for transmitting its communication address to the reader,
the reader comprises computing means for selecting, from among the communication addresses of the communicating objects present, that of at least one communicating object with which the reader must exchange information.

The system is such that, in order to implement the communication protocol:
each communicating object comprises data processing means for alternately and successively selecting a frequency from the first subgroup of frequencies followed by a frequency from the second subgroup of frequencies,
the computing means of the reader make it possible to randomly select the first subgroup of frequencies or the second subgroup of frequencies,
the computing means of the reader make it possible to perform several frequency scans of the frequencies in the selected subgroup of frequencies before performing a scan of the frequencies in the other subgroup of frequencies.

It is thus possible, thanks to this combination of technical features, to reduce the time required for the reader and the communicating object in question to find the frequency of the channel on which they can exchange information.

In a variant of embodiment of the invention, the reader is associated with a mobile telephone unit, particularly a GSM unit. Preferably according to the invention, in this variant of embodiment, the system is such that:
each communicating object comprises detection means for detecting the GSM signals sent by the mobile telephone unit,
each communicating object comprises activation means for activating, based on the GSM signals thus detected, the sending by the second sending means of the response signal to the request.

It is thus possible, thanks to this combination of technical features, to reduce the power consumption of the communicating object by activating the sending of the response signal only at the appropriate time.

In another variant of embodiment of the invention, the communication protocol comprises standby phases and active phases. Preferably according to the invention, in this variant of embodiment, the system is such that the data processing means of the communicating object adapt the duration of the standby phases to the number of requests sent by the readers.

In a variant of embodiment, said reader and said communicating object also comprise connection means for establishing a Bluetooth type connection between said reader and said communicating object in question, using said frequency of the channel on which they can exchange information.

In another variant of embodiment, preferably according to the invention the system is such that:
the data processing means make it possible to give one of the communicating objects the status of master communicating object relative to the other communicating objects, which have the status of slave communicating objects,
the data processing means of the master communicating object make it possible to collect the communication address and/or the specific information from each slave communicating object,
the data processing means of the master communicating object make it possible to respond to the requests sent by the reader.

As a result of this combination of technical features, the reader collects all of the information from the communicating objects.

Preferably according to the invention, in this other variant of embodiment, the system is also such that the data processing means make it possible to transfer to another communicating object the status of master communicating object.

Preferably according to the invention, in this other variant of embodiment, the system is also such that:
the data processing means allow the previous master communicating object to communicate to the new master communicating object the information it has concerning the other communicating objects,
the data processing means of the new master communicating object make it possible to verify the information from the previous master communicating object.

In an advantageous variant of embodiment, the communicating object is linked to an application module that makes it possible to trigger the establishment of the communication by a simple action, particularly a click, from a user of the communicating object.

The invention concerns a communicating object that makes it possible to rapidly establish a Bluetooth type communication between at least one reader, particularly a standard reader, and at least one communicating object, particularly in the form of a chip. The communicating object and the reader have a Bluetooth type communication protocol. The communicating object has a communication address. The Bluetooth type communication protocol implements a radio frequency communication process on channels having specific frequencies. The specific frequencies are divided into a first subgroup of frequencies and a second subgroup of frequencies. The reader comprises first sending means for sending a Bluetooth request, establishing the communication process in order to determine whether at least one communicating object is present in the environment in which the reader is located. The communicating object comprises:
receiving means for receiving the request from the reader,
second sending means for sending a response signal revealing its presence and for transmitting its communication address to the reader.

Each communicating object also comprises, in order to implement the communication protocol, data processing means for alternately and successively selecting a frequency from the first subgroup of frequencies followed by a frequency from the second subgroup of frequencies. The computing means of the reader make it possible to randomly select the first subgroup of frequencies or the second subgroup of frequencies and to frequency scan the frequencies in the selected subgroup of frequencies before performing a scan of the frequencies in the other subgroup of frequencies.

It is thus possible, thanks to this combination of technical features, to reduce the time required for the reader and the communicating object in question to find the frequency of the channel on which they can exchange information.

In a variant of embodiment, the reader is associated with a mobile telephone unit, particularly a GSM unit. Preferably according to the invention, in this variant of embodiment, the communicating object comprises:
detection means for detecting the GSM signals sent by the mobile telephone unit,
activation means for activating, based on the GSM signals thus detected, the sending by the second sending means of the response signal to the request.

It is thus possible, thanks to this combination of technical features, to reduce the power consumption of the communicating object by activating the sending of the response signal only at the appropriate time.

In another variant of embodiment, the communication protocol comprises standby phases and active phases. Preferably according to the invention, in this variant of embodiment the communicating object is such that the data processing means of the communicating object adapt the duration of the standby phases to the number of requests sent by the readers.

In a variant of embodiment, said communicating object comprises connection means for establishing a Bluetooth type connection between said reader and said communicating object in question, using said frequency of the channel on which they can exchange information.

In another variant of embodiment, preferably according to the invention the communicating object is such that:
the data processing means make it possible to give one of the communicating objects the status of master communicating object relative to the other communicating objects, which have the status of slave communicating objects,
the data processing means of the master communicating object make it possible to collect the communication address and/or the specific information from each slave communicating object,
the data processing means of the master communicating object make it possible to respond to the requests sent by the reader.

As a result of this combination of technical features, the reader collects all of the information from the communicating objects.

Preferably according to the invention, in this other variant of embodiment, the communicating object is also such that the data processing means make it possible to transfer to another communicating object the status of master communicating object.

Preferably according to the invention, in the case of this other variant of embodiment, the communicating object is also such that:
the data processing means allow the previous master communicating object to communicate to the new master communicating object the information it has concerning the other communicating objects,
the data processing means of the new master communicating object make it possible to verify the information from the previous master communicating object.

In an advantageous variant of embodiment, said communicating object is linked to an application module that makes it possible to trigger the establishment of the communication by a simple action, particularly a click, from a user of the communicating object.

### BRIEF DESCRIPTION OF THE DRAWINGS

Other characteristics and advantages of the invention will become apparent through the reading of the description of variants of embodiment of the invention given as indicative, nonlimiting examples, and of

FIG. 1 represents an overall diagram of a system in accordance with an embodiment of the invention;

FIG. 2 schematically represents the activation of the Bluetooth communication system through the detection of GSM signals in accordance with an embodiment of the present invention;

FIG. 3 represents the operational algorithm of the activation system of FIG. 2 in accordance with an embodiment of the present invention;

FIG. 4 represents the behavior of a communicating object in individual mode in accordance with an embodiment of the present invention;

FIG. 5 represents the behavior of a slave communicating object in community mode in accordance with an embodiment of the present invention; and,

FIG. 6 represents the operation of a master communicating object in community mode in accordance with an embodiment of the present invention.

### DETAILED DESCRIPTION OF THE EMBODIMENTS

In the remainder of the description, a communicating object will be designated by the terms master object, slave object, or chip, depending on the circumstances.

The standard Bluetooth technological environment to which the present invention belongs was explained at the outset of the specification. Let's review its essential characteristics.

Bluetooth was designed to guarantee a lack of interference between various products communicating with one another. To accomplish this, the Bluetooth protocol works by dividing the 2.45 GHz frequency band into sub-frequencies.

In order to eliminate any risk of interference during a communication, two elements agree to communicate on one of these frequencies.

The connection principle is as follows. First, there is an “inquiry” process, in order to find the Bluetooth elements present to which a device can connect, and then there is a “page” process, which makes it possible to connect to a specified element using its (unique) Bluetooth address, obtained by means of the inquiry process.

We will now describe in detail the standard inquiry process of the Bluetooth protocol in order to illustrate the differences between it and the modified inquiry process according to the invention.

During the establishment of a standard Bluetooth connection, the master object (particularly a portable telephone) initiates an inquiry in order to identify the slave objects (the chips) present in its environment. A slave object responds to a master object by sending the information required to establish a connection with the slave object, particularly its Bluetooth address.

The Bluetooth address is a unique 48-bit number, assigned by the manufacturer.

The inquiry process implements a radio frequency communication process on channels having specific frequencies. There are 32 channels (frequencies) on which an inquiry can be performed. These 32 channels are divided into 2 groups of 16 chapels. For purposes of the following explanation, we'll call the first group “group A” and the second group “group B.” During the inquiry process, the master object hops very quickly among all of the channels in a group of 16 frequencies, sending the inquiry message and listening for a response. The master object repeats this sending and listening process on a group of 16 frequencies 256 times before then performing the same operation on the second group. The slave object hops from group to group slowly, every 1.28 s. It listens on the frequency of the channel in question for the master object performing an inquiry.

The process that consists of repeating the same interrogation 256 times before moving on to the other subgroup requires the slave object to listen actively for quite a long time. This time is particularly long if the slave object is listening to group A while the master may be scanning group B 256 times before moving to group A to find the frequency on which the chip is listening. Moreover, if the slave object must stay awake for a very long time, its power consumption is quite high.

When the slave object receives a packet of information resulting from an inquiry performed by a master object, it does not respond right away. It goes into sleep mode for a random period of time. It only responds to a subsequent inquiry after being woken up. This process is used to minimize collisions in an environment that is highly populated with slave objects.

In the variant of embodiment according to the invention described below, the master object performs an inquiry using a specific process that is different from the standard inquiry process of the Bluetooth protocol.

We will now describe the inquiry process of the Bluetooth protocol, modified according to the invention. To increase the master object's chances of finding the slave object, the slave object listens for 10 ms on a frequency in group A, then for 10 ms on a frequency in group B. Thus, the chances of the master object's finding the slave object are very close to 1.

The listening frequency of the slave object is defined by the following parameters, based on an equation defined in the Bluetooth protocol:
a fixed value written into the slave object during production,
the clock value of the slave object, which is an incremented number

In order to change the frequency of the slave object, a complementary value is added to the clock value. This complementary value is calculated by applying the aforementioned equation defined by the Bluetooth protocol through the microprocessor of the slave object, in order to obtain the value of the desired frequency. The complementary value is therefore determined dynamically based on the value of the desired frequency the value of the offset [sic].

The modified inquiry process also takes the following form:
The slave object listens for 10 ms on a frequency of one of the subgroups (A or B);
If it does not hear anything, it calculates the complementary value so that the listening frequency belongs to the other group;
The slave object listens for another 10 ms period, then
Returns to a sleep phase or responds.

The inquiry process is iterated during the next wakeup phase.

At the end of the inquiry process and after the Bluetooth address of a slave object is obtained, a standard call process, using the Bluetooth address obtained, is used to establish a connection with this slave object in particular.

The variant of embodiment described below is particularly well suited to reducing electric power consumption when the reader is associated with a mobile telephone unit.

In essence, it is desirable for a communicating object, particularly a chip, to be able to listen for a master object while consuming as little power as possible.

A chip's power consumption is dominated by the phases of waking up and searching for a reader. In order to contribute as little as possible to limiting the number of listening phases by the chip for a reader, a method using a GSM transmission detector has been implemented.

Mobile (GSM) telephones are considerably more powerful than Bluetooth transmitters (1-2 watts as opposed to 1 mW for Bluetooth), and most of the time, they are combination devices.

The chip has a signal detector like the LTC5505 which, after having detected a GSM signal, activates the search for a system based on the Bluetooth protocol. A standard or modified Bluetooth protocol can be used to obtain the information contained in the chips.

The GSM signal detector consumes far less power during the listening phases. In fact, since the GSM signal is stronger, it requires less power to detect it. It is thus possible to benefit from a significant reduction in power consumption during the listening phases. This makes it possible to extend the service life of the batteries of the communicating objects.

The variant of embodiment described below is also particularly well suited to reducing electric power consumption when chip density is high (i.e., when a large number of communicating objects are located in the same environment) or when the communicating objects are not very mobile (i.e., when the communicating objects stay together for relatively long periods of time).

This variant of embodiment will hereinafter be designated as a community operation process.

As the description below will illustrate, the community operating mode allows communicating objects that remain in a group for sufficiently long periods to conserve their batteries.

There are two possible community operating modes: the individual mode and the community mode.

These two modes are complementary and describe the operation of the chips.

The individual mode involves a single chip that is seeking a reader or a community to join, or other chips with which to form a community.

The community mode describes the behavior of the chips once the community has been formed, both from the point of view of the master chip and from the point of view of the slave chip belonging to this community.

Forming a community of communicating objects requires that a communicating object be defined, at the start of the process, as the master communicating object, based on a pre-defined algorithm.

The master object then communicates with the individual communicating objects to ask them to join the community. It also has the role of collecting all of the identifiers of the other communicating objects and of responding to the presence of a communicating object reader in order to communicate to it the identifiers of all the communicating objects in the community of communicating objects. Thus, the reader collects all of the identifiers in a single read operation.

In order not to consume all of this chip's power, this master communicating object function is transferred in round-robin fashion. The communicating object that responded first during the collection of the identifiers in turn becomes the next master communicating object of the community, and the master communicating object goes back to being a slave communicating object. This process is reiterated continuously. The master assigns to the next communicating object the role of master object of the community and the time during which the community must remain in sleep mode prior to waking up. All of the identifiers of the community are transmitted to the new master communicating object by the previous master communicating object. The new master communicating object verifies whether the information it has received is correct by performing a scan of the other identifiers.

Prior to joining a community, the communicating object is in individual mode. During this mode, the communicating object seeks:
to join a community, or
other communicating objects for creating a community, and/or
a communicating object reader to which to transmit its information.

Both of these community operating modes offer the following advantages:
a much shorter connection time for the communication between the communicating objects and the reader,
a much longer service life of the battery,
the ability to have a high communicating object density.

In order to further reduce the power consumed, in another variant of embodiment the chip has an adaptive wakeup means. This means that if the communicating object has not seen any communicating object reader after a substantial period of time, it will progressively lengthen the time interval between two wakeups. Likewise, if the communicating object is in an environment in which there are a lot of connections, it will shorten the time between wakeups in order to optimize the transmissions. It is thus possible to minimize power consumption, for example in the case where a communicating object is located in a warehouse at night, when no active searching is necessary.

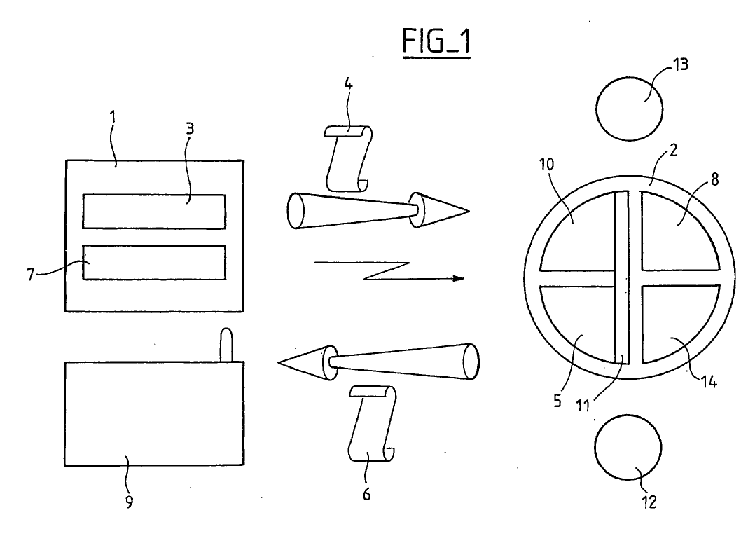

We will now describe the technical means for implementing the processes according to the invention by referring to FIG. 1, which represents an overall diagram of a system according to the invention.

The system described makes it possible to rapidly establish a Bluetooth type communication between at least one reader 1, particularly a standard reader, and at least one communicating object 2, particularly in the form of a chip. The communicating object 2 and the reader 1 use a Bluetooth type communication protocol. The communicating object 2 has a communication address. The Bluetooth type communication protocol implements a radio frequency communication process on channels having specific frequencies. The specific frequencies are divided into a first subgroup of frequencies A and a second subgroup of frequencies B.

The reader 1 comprises first sending means 3 for sending a Bluetooth request 4, establishing the communication process. The purpose of this request is to determine whether at least one communicating object 2 is present in the environment in which said reader 1 is located.

Each communicating object 2 comprises receiving means 14 for receiving the Bluetooth request 4. Each communicating object 2 also comprises two sending means 5 for sending a response signal 6 revealing its presence and for transmitting its communication address to said reader 1.

The reader 1 comprises computing means 7 for selecting, from among the communication addresses of the communicating objects 2 present, that of at least one communicating object 2 with which said reader 1 must exchange information.

In order to implement the communication protocol, each communicating object 2 comprises data processing means 8. These data processing means 8 make it possible to alternately and successively select a frequency from the first subgroup of frequencies A followed by a frequency from the second subgroup of frequencies B.

The computing means 7 of the reader 1 also make it possible to randomly select the first subgroup of frequencies A or the second subgroup of frequencies B.

The computing means 7 of the reader 1 also make it possible to perform several frequency scans of the frequencies in the selected subgroup of frequencies before performing a scan of the frequencies in the other subgroup of frequencies.

It is thus possible to reduce the time required for said reader 1 and the communicating object 2 in question to find the frequency of the channel on which they can exchange information.

In the variant of embodiment of the invention represented in the figure, the reader 1 is associated with a mobile telephone unit 9, particularly a GSM unit. In this variant, each communicating object 2 comprises:
detection means 10 for detecting the GSM signals sent by the mobile telephone unit 9,
activation means 11 for activating, based on the GSM signals thus detected, the sending by the second sending means 5 of the response signal 6 to the Bluetooth request 4.

It is thus possible to reduce the power consumption of the communicating object 2 by activating the sending of the response signal 6 only at the appropriate time.

The communication protocol comprises standby phases and active phases. The data processing means 8 of the communicating object 2 adapt the duration of the standby phases to the number of requests sent by said readers.

In the variant of embodiment represented in the figure, the data processing means 8 make it possible to give one of the communicating objects the status of master communicating object 12 relative to the other communicating objects 2. The latter have the status of slave communicating objects 13. Also in the variant of embodiment represented in the figure, the data processing means 8 of the master communicating object 12 make it possible to collect the communication address and/or said specific information from each slave communicating object 13. Also in the case of this variant of embodiment, said data processing means 8 of the master communicating object 12 make it possible to respond to the Bluetooth requests 4 sent by said reader 1.

Thus, the reader 1 can collect all of the information from the communicating objects.

In the variant of embodiment represented in the figure, the data processing means 8 make it possible to transfer to another communicating object the status of master communicating object 12. The data processing means 8 also allow the previous master communicating object 12 to communicate to the new master communicating object 12 the information it has concerning the other communicating objects 2. The data processing means 8 of the new master communicating object 12 make it possible to verify the information from the previous master communicating object 12.

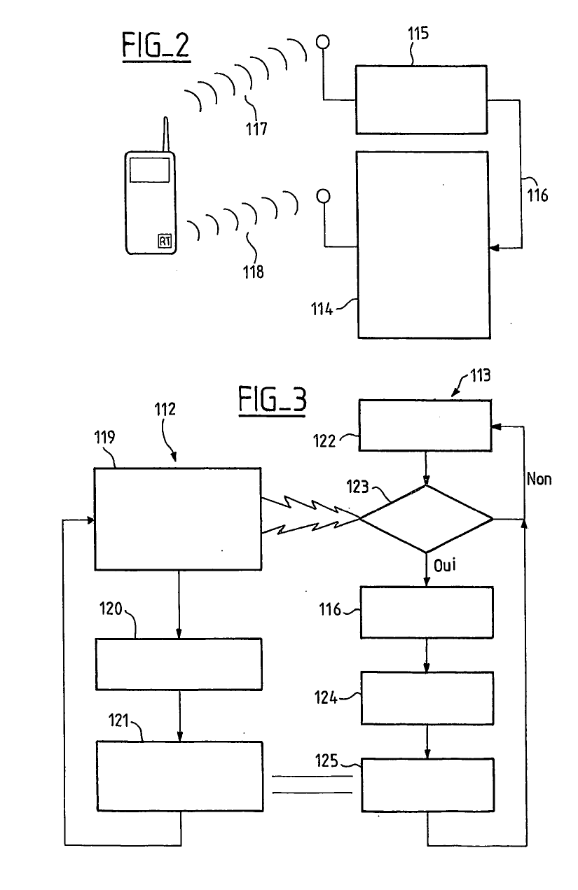

We will now describe FIG. 2, which schematically represents the activation of the Bluetooth communication system through the detection of GSM signals.

The numerical references below designate the following technical elements:
114: Bluetooth equipment
115: Signal detector
116: Wakeup signal
117: GSM signal
118: Bluetooth signal

The Bluetooth communication function is activated through the detection of a GSM field signal of a certain amplitude. If this signal is detected, then the function is activated; otherwise, the system continues its search.

We will now describe FIG. 3, which represents the operational algorithm of the activation system of FIG. 2.

The numerical references below designate the following technical elements:
112: Communicating object reader
113: Communicating object
119: Phase 119: The user activates the GSM system in the portable reader
120: Phase 120: Resumption of Bluetooth activity
121: Phase 121: Reception of the identifier of the communicating object
122: Phase 122: Listening for a signal
123: Phase 123: Is the signal above a given limit?
116: Wakeup signal for the Bluetooth part
124: Phase 24 for starting the Bluetooth activity
125: Phase 125 for transferring the identifiers of the communicating objects

The communicating object only activates the Bluetooth communication mode if the communicating object detects a GSM signal of a certain given amplitude. If this signal is detected, then the Bluetooth activity is started, and if a communicating object reader is present, then the communicating object transfers its identifier to it.

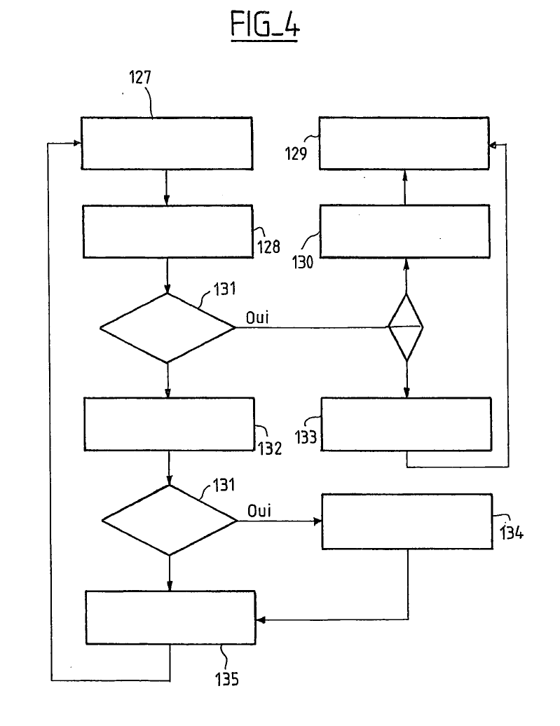

We will now describe FIG. 4, which represents the behavior of a communicating object in individual mode.

The numerical references below designate the following technical elements:
127: Phase 127: Wakeup of the system
128: Phase 128: The sending and listening by a communicating object (inquiry mode or Bluetooth call) for the master of the community OR for other chips in individual mode.
129: Phase 129: Enters into community mode
130: Phase 130: Joins the community if it receives a response from the master of the community
131: Phase 130: Is there a response?
132: Phase 132: Search for a communicating object reader
133: Phase 133: Creation of a new community if there is a response from an individual
134: Phase 134: Sending the identifier of the chip
131: Phase 131: Is there a response?
135: Phase 135: Sleep phase for a given period

When a communicating object is alone, it seeks to enter into communication with a community of communicating objects or with other communicating objects seeking to form a community. If the communicating object receives a response from a communicating object having the status of master of a community, then it joins the community. If the communicating object finds other communicating objects in individual mode, then they form a community.

In the case where the communicating object does not find either of these two types of elements, it then searches for a communicating object reader. If it finds one, then it communicates its identifier to it; if not, it returns to a sleep phase until the next cycle of these three elements.

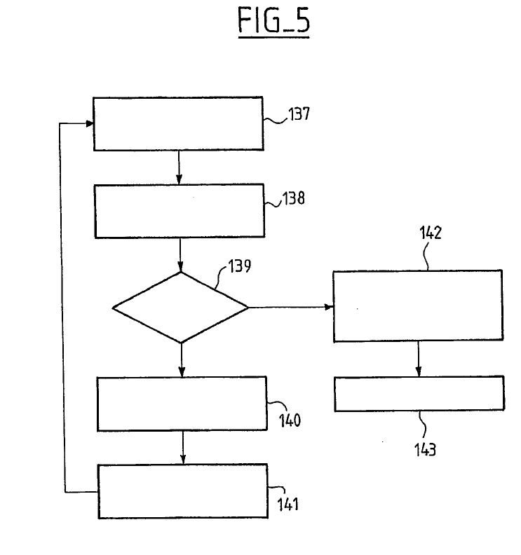

We will now describe FIG. 5, which represents the behavior of a slave communicating object in community mode.

The numerical references below designate the following technical elements:
137: Phase 137: Wakeup time imposed by the current master
138: Phase 138: Listening for a communication from the new master
139: Phase 139: Communication?
140: Phase 140: Transmits the identifier of the chip to the new master and obtains the wakeup time
141: Phase 141: Entry into deep sleep mode
142: Phase 142: Either a chip has been removed from the community of chips or a new master has been removed.
143: Phase 143: Entry into individual mode

When a communicating object is one of the members of a community with a master communicating object, it behaves as follows:

The master imposes the wakeup time. Once woken up, the slave object searches for a signal from the master. If this communication has taken place, then the slave object transmits its identifier and obtains the new wakeup time, then goes into sleep mode.

If this communication has not been established, either the master object has been removed or this slave object has been removed from the community. The slave then goes into individual mode.

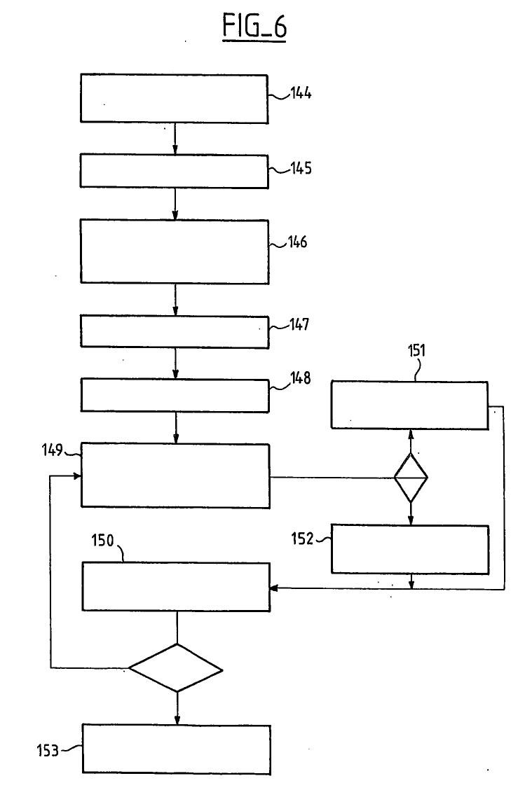

We will now describe FIG. 6, which represents the operation of a master communicating object in community mode.

The numerical references below designate the following technical elements:
144: Phase 144: A chip is designated as the master by the previous master, and the old master becomes a slave.
145: Phase 145: Community mode-Master
146: Phase 146: The chip performs an inquiry process to verify which chips belong to the community. All of the identifiers are recorded.
147: Phase 147: The master chip gives all the chips the wakeup interval.
148: Phase 148: The chip designates a chip to become the master.
149: Phase 149: The chip searches for a reader and for chips seeking to join the community.
150: Phase 150: The chip transmits the updated list to the members of the community at defined intervals.
151: Phase 151: If a reader is found, all the identifiers of the community are transferred.
152: Phase 152: If a new chip is found, the wakeup information is transmitted. Its identifier is added to the list.
153: Phase 153: After a defined time, the role of master is transferred to the next master.

A communicating object is designated as the master by the previous master. The master performs a process for verifying the identifiers transmitted by the previous master. All of the identifiers are stored.

The master then gives all the slaves their wakeup time, and it designates the new master of the community.

The master searches for a communicating object reader to which to transmit the identifiers or for a communicating object to be joined to the community.

If a reader is found, all of the stored identifiers are transmitted. In the case where the master finds a communicating object, its identifier is added to the list and the wakeup time is communicated to it.

At the end of the cycle, the new master assumes its role and the old one goes back to being a slave.

The solution according to the invention makes it possible to open up access to a wide range of innovative applications, while making Bluetooth functionalities accessible from a communicating object.

Making Bluetooth work in a very low power consumption mode opens up the possibility of using it from a communicating object, thus making objects “intelligent.” However, the acceleration of the connection time is a principle that can be applied to systems that are powered (i.e., have a main power source) but that need extremely fast access to information.

A constantly growing volume of data is stored in networks, and the problem lies in accessing it. The purpose of the technology according to the invention is to establish, through its interface, a direct connection between the physical world and the users via their standard communication device equipped with a Bluetooth connection. Thus, the invention allows immediate access to the information associated with a given object.

In its consumer application, the technological solution according to the invention makes it possible to provide many value-added services via portable telephones and other standard communication devices (PDAs, etc.) For example, a user can immediately obtain information associated with a billboard, a poster for a show, or a painting exhibited in a museum by clicking directly at these objects using a mobile telephone device. He can thus access the most relevant information with one click.

Fabien Beckers' French patent application No. 01/06883, filed on May 25, 2001, describes how it is possible to “surf” in a city, just like an internaut explores a website.

The technology according to the invention makes it possible to link the profusion of data to the need to disseminate knowledge intelligently in response to real needs. The technology according to the invention makes it possible to respond to the growing problem of quick access to relevant information, making it possible to move from a world of data to a world of information and knowledge.

1. A method for rapidly establishing a Bluetooth type communication between a reader having a Bluetooth type communication protocol and a communicating object having said Bluetooth type communication protocol and a communication address, said Bluetooth type communication protocol implementing a radio frequency communication process on channels having specific frequencies divided into a first subgroup of frequencies and a second subgroup of frequencies, the method comprising the steps of:
sending a Bluetooth request and establishing said communication process by said reader to determine whether at least one communicating object is present in the environment in which said reader is located;
transmitting a response signal to reveal its presence and said communication address to said reader by said communicating object that receives said Bluetooth request;
selecting said at least one communicating object with which said reader exchanges information from among the received communication addresses of said communicating objects by said reader;
alternately and successively selecting a frequency from the first subgroup of frequencies followed by a frequency from the second subgroup of frequencies by said communicating object;
randomly selecting the first subgroup of frequencies or the second subgroup of frequencies by said reader; and
performing frequency scans of the frequencies in the selected subgroup of frequencies before performing a frequency scan of the other subgroup of frequencies by said reader, thereby reducing the time required for said reader and said communicating object to find the frequency of the channel on which they can exchange information.

2. The method of claim 1, wherein said reader is associated with a mobile telephone unit; and further comprising the steps of:
detecting GSM signals sent by said mobile telephone unit by said communicating object; and
activating the sending of said response signal to said request based on the detected GSM signals by said communicating object, thereby reducing the power consumption of said communicating object by activating the sending of said response signal only at the appropriate time.

3. The method of claim 1, wherein said communication protocol comprises standby phases and active phases; and further comprising the step of adapting the duration of said standby phases to a number of said Bluetooth requests sent by said reader.

4. The method of claim 1, further comprising the step of establishing a Bluetooth connection between said reader and said communicating object using said frequency of the channel on which they can exchange information.

5. The method of claim 1, further comprising the steps of:
giving one of said communicating objects a status of a master communicating object relative to the other communicating objects having status of slave communicating objects;
collecting the communication address and/or said specific information from said slave communicating objects by said master communicating object;
responding to said Bluetooth requests sent by said reader by said master communicating object so that said reader collects all of the information from said plurality of communicating objects.

6. The method of claim 5, further comprising the step of transferring to another communicating object the status of a master communicating object by said master communicating object.

7. The method of claim 6, further comprising the steps of:
communicating to the new master communicating object the information concerning the other communicating objects by the previous master communicating object; and
verifying the information from the previous master communicating object by said new master communicating object.

8. The method of claim 1 being activated by means of an application linked to said communicating object when said application is activated by a user of said communicating object.

9. A system for rapidly establishing a Bluetooth type communication between a reader and a communicating object, comprising
a reader having a Bluetooth type communication protocol implementing a radio frequency communication process on channels having specific frequencies divided into a first subgroup of frequencies and a second subgroup of frequencies, and comprising a first sending means for sending a Bluetooth request and establishing said communication process to determine whether at least one communicating object is present in the environment in which said reader is located; and
a plurality of communicating objects, each having a communication address and said Bluetooth type communication protocol, and comprising:
a second sending means for sending a response signal to reveal its presence and for transmitting said communication address to said reader; and
a data processor for alternately and successively selecting a frequency from the first subgroup of frequencies followed by a frequency from the second subgroup of frequencies; and
wherein said reader further comprises a processor for:
selecting said at least one communicating object with which said reader exchanges information from among the communication addresses of communicating objects present;
randomly selecting the first subgroup of frequencies or the second subgroup of frequencies; and
performing frequency scans of the frequencies in the selected subgroup of frequencies before performing a scan of the frequencies in the other subgroup of frequencies, thereby reducing the time required for said reader and said at least one communicating object to find the frequency of the channel on which they can exchange information.

10. The system of claim of claim 9, wherein said reader is associated with a mobile telephone unit; and wherein each communicating object further comprises a detection means for detecting GSM signals sent by said mobile telephone unit and an activation means for activating the sending of said response signal to said request by said second sending means based on the detected GSM signals, thereby reducing the power consumption of said communicating object by activating the sending of said response signal only at the appropriate time.

11. The system of claim 9, wherein said communication protocol comprises standby phases and active phases; and wherein said data processor of said at least one communicating object is operable to adapt the duration of the standby phases to the number of said Bluetooth requests sent by said reader.

12. The system of claim 9, further comprising a connection means for establishing a Bluetooth type connection between said reader and said at least one communicating object using said frequency of the channel on which they can exchange information.

13. The system of claim 9, wherein one of said plurality of communicating objects is given a status of a master communicating object relative to the other communicating objects having a status of slave communicating objects; and wherein said data processor of said master communicating object is operable to:
collect the communication address and/or said specific information from each slave communicating object; and
respond to said Bluetooth requests sent by said reader so that said reader collects all of the information from said plurality of communicating objects.

14. The system of claim 13, wherein said data processor of said master communicating object is operable to transfer to another communicating object the status of master communicating object.

15. The system of claim 14, wherein said data processor of the previous master communicating object is operable to communicate to the new master communicating object the information concerning the other communicating objects; and wherein said data processor of the new master communicating object is operable to verify the information from the previous master communicating object.

16. The system of claim 9, wherein said communicating object is linked to an application module which is operable to trigger the establishment of the communication between said communicating object and said reader, and wherein said application module being activated by a simple action from a user of said communicating object.

17. A communicating object for rapidly establish a Bluetooth type communication with a reader having a Bluetooth type communication protocol implementing a radio frequency communication process on channels having specific frequencies divided into a first subgroup of frequencies and a second subgroup of frequencies, said communicating object having said Bluetooth type communication protocol and a communication address, and wherein said reader comprises a first sending means for sending a Bluetooth request and establishing said communication process to determine whether at least one communicating object is present in the environment in which said reader is located, said communicating object comprising:
a receiving means for receiving said Bluetooth request from said reader;
a second sending means for sending a response signal revealing its presence and transmitting said communication address to said reader; and
a data processor for alternately and successively selecting a frequency from the first subgroup of frequencies followed by a frequency from the second subgroup of frequencies; and
wherein a processor of said reader is operable to:
randomly select the first subgroup of frequencies or the second subgroup of frequencies; and
frequency scan the frequencies in the selected subgroup of frequencies before performing a scan of the frequencies in the other subgroup of frequencies, thereby reducing the time required for said reader and said communicating object to find the frequency of the channel on which they can exchange information.

18. The communicating object of claim 17, wherein said reader is associated with a mobile telephone unit; and further comprising:
a detection means for detecting GSM signals sent by said mobile telephone unit; and
an activation means for activating the sending of said response signal to said Bluetooth request by said second sending means based on the detected GSM signals, thereby reducing the power consumption of said communicating object by activating the sending of said response signal only at the appropriate time.

19. The communicating object of claim 17, wherein said communication protocol comprises standby phases and active phases; and wherein said data processor of said communicating object is operable to adapt the duration of the standby phases to a number of said Bluetooth requests sent by said reader.

20. The communicating object of claim 17, further comprising a connection means for establishing a Bluetooth type connection between said reader and said communicating object using said frequency of the channel on which they can exchange information.

21. The communicating object of claim 17, wherein said data processor is operable to:
give said communicating object a status of a master communicating object relative to the other communicating objects having a status of slave communicating objects;
collect the communication address and/or said specific information from each slave communicating object; and
respond to said Bluetooth requests sent by said reader so that said reader collects all of the information from the communicating objects.

22. The communicating object of claim 21, wherein said data processor of said master communicating object is operable to transfer to another communicating object the status of master communicating object.

23. The communicating object of claim 22, wherein said data processor of said master communicating object is operable to communicate to the new master communicating object the information concerning the other communicating objects; and wherein said data processor of the new master communicating object is operable to verify the information from said master communicating object.

24. The communicating object of claim 17, wherein said communicating object is linked to an application module which is operable to trigger the establishment of the communication between said communicating object and said reader, and wherein said application module being activated by a simple action from a user of said communicating object.
